(19) United States
(12) Patent Application Publication
(10) Pub. No.: US 2011/0007025 A1
(43) Pub. Date: Jan. 13, 2011

(54) TOUCH DEVICE HAVING DIFFERENT POLARIZING DIRECTIONS

(75) Inventors: JEAH-SHENG WU, Miao-Li County (TW); JIA-SHYONG CHENG, Miao-Li County (TW); CHIH-HAN CHAO, Miao-Li County (TW); CHUN-YI HU, Miao-Li County (TW)

Correspondence Address: Altis Law Group, Inc.;ATTN: Steven Reiss, 288 SOUTH MAYO AVENUE, CITY OF INDUSTRY, CA, 91789, US

(73) Assignee: CHIMEI INNOLUX CORPORATION, Miao-Li County (TW)

(21) Appl. No.: 12/790,855

(22) Filed: May 31, 2010

(30) Foreign Application Priority Data
Jul. 8, 2009 (CN) 200910304145.X

(51) Int. Cl. G06F 3/045

(52) U.S. Cl. 345/174; 178/18.05

(57) ABSTRACT

A touch device including a first slice and a second slice separated from the first slice is provided. The first slice has a first dielectric layer having conductive properties. The first dielectric layer provides a first polarizing direction. The second slice has a second dielectric layer with conductive properties. The second dielectric layer provides a second polarizing direction. The first polarizing direction is different form the second polarizing direction.

### BACKGROUND OF DISCLOSURE

1. Field of the Disclosure

The present disclosure generally relates to a touch device, and more particularly to a resistance type touch device.

2. Description of Related Art

FIG. 1 is a schematic cross-sectional view of an electronic device 10 with a touch control function. The electronic device 10 includes a display device 12 and a resistance type touch panel 14 usually disposed on the display device 12. The resistance type touch panel 14 includes a glass substrate 16, a first indium tin oxide (ITO) layer 18, a plurality of spacers 20, a second indium tin oxide (ITO) layer 22, and an insulating slice 24. The first ITO 18 is disposed on the glass substrate 16. The second ITO 22 is disposed on the insulating slice 24 and opposite to the first ITO 18. The spacers 20 is disposed on the first ITO 18 and located between the first ITO 18 and the second ITO 22 for ensuring a fixed distance existed between the first ITO 18 and the second ITO 22.

However, faults in the designing and assembling of the conventional resistance type touch panel 14 may also result in the generation of moire under the light irradiation when the first ITO 18 is close to the second ITO 22. This generation of moiré is known as Newton's rings. Since the insulating slice 24 is made of a soft material, and due to the changing of temperature and humidity, the insulating slice 24 may have a lumpy surface and further cause the problem of Newton's rings.

### SUMMARY OF THE DISCLOSURE

Other objects and advantages of the disclosure can be further illustrated by the technical features broadly embodied and described as follows.

One embodiment of the present disclosure discloses a touch device, which includes a first slice and a second slice. The first slice includes a first dielectric layer having conductive properties. The first dielectric layer provides a first polarizing direction. The second slice is separated from the first slice. The second slice has a second dielectric layer having conductive properties, and the second dielectric layer provides a second polarizing direction. Herein, the first polarizing direction is different from the second polarizing direction.

The second slice further has a substrate, the substrate has transparent property, and the second dielectric layer is disposed on the substrate. The first slice further has a film with transparent property, and the first dielectric layer is disposed on the film. The first dielectric layer with transparent and conductive properties has a plurality of first substances. The first substances show first line arrangements extending along a first direction. The second dielectric layer with transparent and conductive properties has a plurality of second substances. The second substances show second line arrangements extending along a second direction. The first direction is different from the second direction.

In the embodiment of the present disclosure, a material of the first substances and a material of the second substances at least one is a carbon nanotube.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic cross-sectional view of an electronic device with a touch control function.

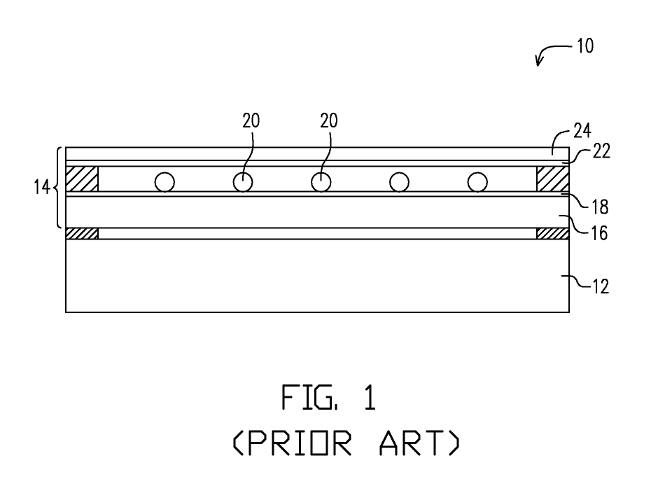

FIG. 2 is a schematic cross-sectional view of a touch panel according to one embodiment of the present disclosure.

FIG. 3 is a schematic view illustrating relative positions of a first dielectric layer and a second dielectric layer of a touch device according to the embodiment of the present disclosure.

### DESCRIPTION OF EMBODIMENTS

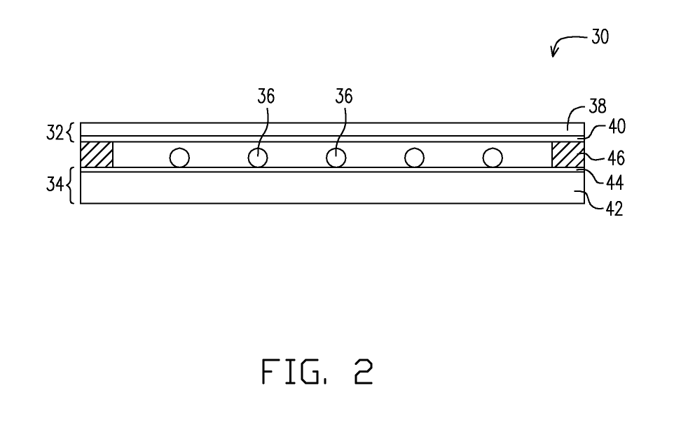

FIG. 2 is a schematic cross-sectional view of a touch device 30 according to one embodiment of the present disclosure. The touch device 30, in this embodiment, is adapted to be disposed on the display device (not shown), for example, disposed on a liquid crystal display panel for the user to perform operations. The touch device 30 includes a first slice 32, a second slice 34, and a plurality of spacers 36.

Referring to FIG. 2, the first slice 32 includes a film 38 and a first dielectric layer 40. The film 38 has the characteristics of both transparency and insulation. A thickness of the film 38 is less than about 0.05 mm and a material of the film 38 includes polymer, for example, polyester (PET). The first dielectric layer 40 having transparent and conductive properties is disposed on the film 38. The second slice 34 is separated from the first slice 32 and includes a substrate 42 and a second dielectric layer 44. The substrate 42 has the characteristics of both transparency and insulation and a material of the substrate 42 includes polymer or glass. The polymer is, for example, polyester or polycarbonate (PC) so as to process treatment. The second dielectric layer 44 having transparent and conductive properties is disposed on the substrate 42 and opposite to the first dielectric layer 40. The second dielectric layer 44 is separated from the first dielectric layer 40 by a distance, for example, 80 μm. The spacers 36 are disposed between the first dielectric layer 40 and the second dielectric layer 44 so as to ensure the first dielectric layer 40 and the second dielectric layer 44 under a separate condition when the user does not press the touch device 30. In addition, the touch device 30 further has an agglutination substance 46. The agglutination 46 is disposed between the two sides of the first slice 32 and the two sides of the second slice 34 so that the first slice 32 and the second slice 34 are connected to each other.

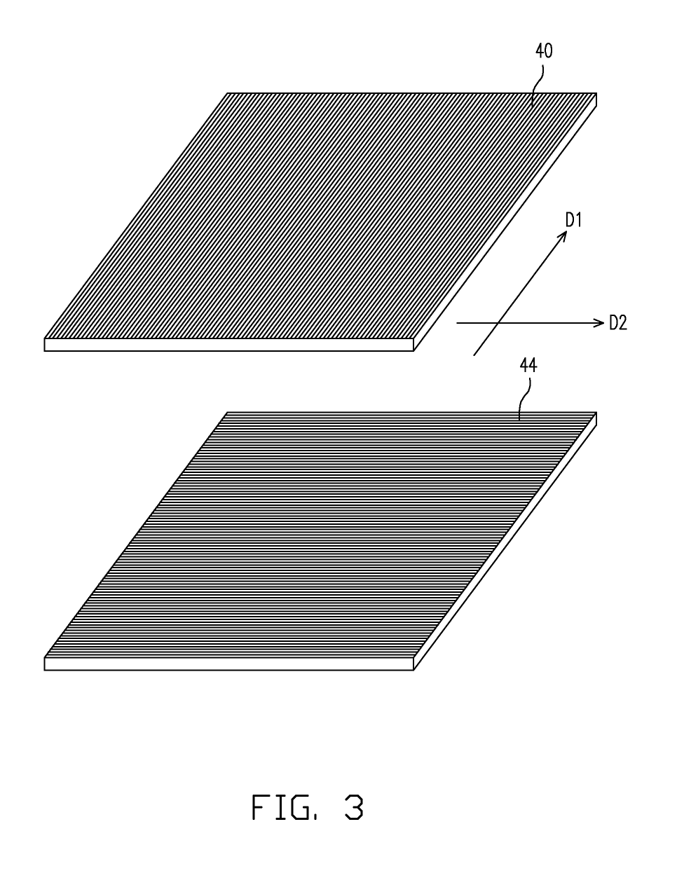

FIG. 3 is a schematic view illustrating relative positions of the first dielectric layer 40 and the second dielectric layer 44 of the touch device 30 according to the embodiment of the present disclosure. The first dielectric layer 40 has a plurality of first substances, and a material of the first substances is, for example, carbon nanotubes. The second dielectric layer 44 has a plurality of second substances, and the second substances are arranged in second line arrangements extending along the same direction substantially. The first substances show first line arrangements extending along a first direction Dl substantially, and two adjacent first substances on each first line arrangement are connected to each other so that the first substances on each first line arrangement are connected to form the filament and constitute the property of conductive anisotropism, and therefore the first dielectric layer 40 provides a first polarizing direction. The second dielectric layer 44 has a plurality of second substances, and a material of the second substances is, for example, carbon nanotubes. The second substances show second line arrangements extending along a second direction D2 substantially, and two adjacent second substances on each second line arrangement are connected to each other so that the second substances on each second line arrangement are connected to form the filament and constitute the property of conductive anisotropism, and therefore the second dielectric layer 44 provides a second polarizing direction. The first direction D1 of the first line arrangement is different from the second direction D2 of the second line arrangement so that the first polarizing direction is different from the second polarizing direction. Therefore, the interference phenomenon produced by the light passing through the conventional touch device may be disrupted to avoid the problem of Newton's rings. In the embodiment of the present disclosure, the included angles between the first line arrangements and the second line arrangements range from about 45 degrees to about 135 degrees. When the included angle between the first line arrangement and the second line arrangement is about 90 degrees, the interference phenomenon can be eliminated to achieve the most preferable effect.

In the embodiment of the present disclosure, the first substances, for example, carbon nanotubes, arranged in first line arrangements and connected to form the filament in the above-mentioned first dielectric layer 40 also make the first dielectric layer 40 have a haze which is more than about 0 and smaller than about 15%. The second substances, for example, carbon nanotubes, arranged in second line arrangements and connected to form the filament in the above-mentioned second dielectric layer 44 also make the second dielectric layer 44 have the haze which is more than about 0 and smaller than about 15%. Since the haze of the first dielectric layer 40 and the haze of the second dielectric layer 44 cause the light scattering, the interference phenomenon produced by the light passing through the conventional touch device may be disrupted to avoid the problem of Newton's rings.

Since the first dielectric layer 40 of the touch device 30 in the embodiment of the present disclosure has the first substances arranged in first line arrangements and connected to form the filament and the second dielectric layer 44 has the second substances arranged in second line arrangements and connected to form the filament, the first dielectric layer 40 and the second dielectric layer 44 provide different polarizing directions. Therefore, the interference phenomenon produced by the light passing through the conventional touch device may be disrupted. In addition, the first dielectric layer 40 and the second dielectric layer 44 also provide the haze to cause the light scattering, so that the interference phenomenon produced by the light passing through the conventional touch device may also be disrupted.

It will be apparent to those skilled in the art that various modifications and variations can be made to the present disclosure without departing from the scope or spirit of the disclosure. In view of the foregoing, it is intended that the present disclosure cover modifications and variations of this disclosure provided they fall within the scope of the following claims and their equivalents. Any of the embodiments or any of the claims of the disclosure does not need to achieve all of the advantages or features disclosed by the present disclosure. Moreover, the abstract and the headings are merely used to aid in searches of patent files and are not intended to limit the scope of the claims of the present disclosure.

What is claimed is:

1. A touch device, comprising:
a first slice comprising a first dielectric layer having conductive properties, wherein the first dielectric layer provides a first polarizing direction; and
a second slice separated from the first slice, wherein the second slice comprises a second dielectric layer with conductive properties, the second dielectric layer provides a second polarizing direction, and the first polarizing direction is different from the second polarizing direction.

2. The touch device as claimed in claim 1, wherein the second dielectric layer has the characteristics of both conductivity and transparency.

3. The touch device as claimed in claim 2, wherein the second slice further has a substrate with transparent properties, and the second dielectric layer is disposed on the substrate.

4. The touch device as claimed in claim 3, wherein a material of the substrate includes polyester or polycarbonate.

5. The touch device as claimed in claim 1, wherein the first dielectric layer has the characteristics of both conductivity and transparency.

6. The touch device as claimed in claim 5, wherein the first slice further has a film with transparent property, and the first dielectric layer is disposed on the film.

7. The touch device as claimed in claim 1, further comprising a plurality of spacers, wherein the first dielectric layer is opposite to the second dielectric layer, and the spacers are disposed between the first dielectric layer and the second dielectric layer.

8. The touch device as claimed in claim 1, wherein the first dielectric layer has a plurality of first substances, and the first substances show first line arrangements extending along a first direction substantially, the second dielectric layer has a plurality of second substances, and the second substances show second line arrangements extending along a second direction substantially, and the first direction is different from the second direction.

9. The touch device as claimed in claim 8, wherein at least one of a material of the first substances and a material of the second substances comprises carbon nanotubes.

10. The touch device as claimed in claim 9, wherein included angles between the first line arrangements and the second line arrangements range from about 45 degrees to about 135 degrees.

11. The touch device as claimed in claim 10, wherein the included angle between the first line arrangement and the second line arrangement is about 90 degrees.
